(19) United States
(12) Patent Application Publication
(10) Pub. No.: US 2013/0284532 A1
(43) Pub. Date: Oct. 31, 2013

(54) SECONDARY STEERING SYSTEM WITH MARGIN PRESSURE DETECTION

(71) Applicants: Brian J. McVey, Joliet, IL (US); Beau D. Kuipers, Morris, IL (US)

(72) Inventors: Brian J. McVey, Joliet, IL (US); Beau D. Kuipers, Morris, IL (US)

(73) Assignee: Caterpillar Inc., Peoria, IL (US)

(21) Appl. No.: 13/455,449

(22) Filed: Apr. 25, 2012

(51) Int. Cl. B62D 3/14; F15B 1/02; F15B 15/00; F16D 31/00

(52) U.S. Cl. 180/403; 60/459; 60/413; 60/327

(57) ABSTRACT

A steering system can include a steering control valve, primary and secondary sources of pressurized fluid, and a controller. The primary and secondary sources of pressurized fluid can be fluidly connected to the steering control valve. The primary source of pressurized fluid can be configured to sense a load pressure requirement from the steering control valve. The controller can be communicably coupled to the primary and secondary sources of pressurized fluid. The controller can monitor a margin pressure of the primary source of pressurized fluid. The controller can determine an operational status of the primary source of pressurized fluid based on the monitored margin pressure.

### TECHNICAL FIELD

The present disclosure relates to a steering system and more particularly to the steering system having a supplemental power steering.

### BACKGROUND

Secondary pump steering systems are utilized as a supplemental source of power in the event of failure of a primary pump steering system in mobile hydraulic systems. Known mobile hydraulic systems make use of a pair of pressure sensors connected to each of the primary and secondary pump steering systems to detect the failure of the steering systems, and especially the primary pump steering system. As per compliance with regulations, visual or audio warnings are provided to an operator when such a failure of the primary pump steering system is detected. However, in some situations false warnings are provided to the operator even when the primary steering system is healthy. For example, a faulty warning typically is sent to the operator in response to a healthy primary steering pump running lower than normal, such as over-running loads, and the secondary steering pump is activated. As a result, the operator should stop the productivity of machine operations in order for the steering systems to be evaluated by a technician and the warning deactivated. It would be desirable to reduce the amount of faulty warnings attributed to the steering systems when the primary steering pump is indeed healthy, such that the machine's productivity can be increased.

In one example, United States Published Application Number 2011/0264321 describes a computer-implemented method of diagnosing a vehicle hydraulic power steering system and steering diagnostic systems for executing the same. The diagnostic systems are configured to detect a steering system condition based on an evaluation of a steering pump outlet pressure, an engine speed and/or a steering wheel position. The system sends a warning signal when a predetermined steering system condition is detected.

### SUMMARY OF THE DISCLOSURE

In one aspect of the present disclosure, a steering system is provided. The steering system can include at least one of a steering control valve, a primary and a secondary source of pressurized fluid, and a controller. The primary and secondary sources of pressurized fluid can be fluidly connected to the steering control valve. The primary source of pressurized fluid can be configured to sense a load pressure requirement from the steering control valve. The controller can be communicably coupled to the primary and secondary sources of pressurized fluid. The controller can be configured to monitor a margin pressure of the primary source of pressurized fluid. The controller can be also configured to determine an operational status of the primary source of pressurized fluid based on the monitored margin pressure.

In another aspect, a method for determining health of a primary source of pressurized fluid is provided. A signal indicative of a load pressure requirement associated with a steering command can be received. A signal indicative of a discharge pressure associated with a primary source of pressurized fluid can be received. A margin pressure associated with the primary source of pressurized fluid based on the received signals can be monitored. An operational status of the primary source of pressurized fluid based on the monitored margin pressure can be determined.

Other features and aspects of this disclosure will be apparent from the following description and the accompanying drawings.

### BRIEF DESCRIPTION OF THE DRAWINGS

FIG. 1 is a diagrammatic view of an exemplary work machine;

FIG. 2 is a block diagram of a steering system; and

FIG. 3 is a process for determining an operational status of a primary source of pressurized fluid.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts.

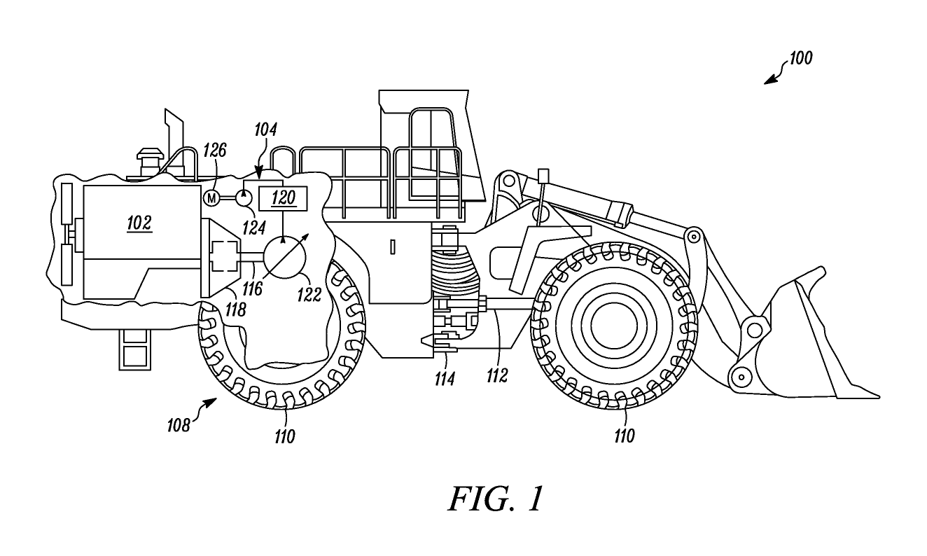

FIG. 1 illustrates an exemplary work machine 100, according to one embodiment of the present disclosure. It should be understood that the work machine 100 may embody any mobile machine that performs some type of operation associated with an industry such as mining, construction, farming, or any other industry known in the art. For example, the work machine 100 may be an earthmoving machine such as a wheel loader, as shown in the accompanied figure, a dump truck, a backhoe, a motor grader, or any other suitable operation-performing machine. As shown in FIG. 1, the work machine 100 may include a power source 102, a steering system 104, and a transmission connected to at least one driven traction device 108.

The power source 102 may be an engine such as, for example, a diesel engine, a gasoline engine, a gaseous fuel powered engine such as a natural gas engine, or any other engine apparent to one skilled in the art. The power source 102 may also embody another source of power such as a fuel cell, a power storage device, or any other source of power known in the art.

The traction device 108 may include wheels 110 located on each side of the work machine 100 (only one side shown). Alternatively, the traction device 108 may include tracks, belts or other traction devices. Additionally, in another embodiment, the traction device 108 may include a differential gear assembly configured to divide power from the power source 102 between the wheels 110 located on either side of the work machine 100. The differential gear assembly may allow the wheels 110 on one side of the work machine 100 to turn faster than the wheels 110 located on an opposite side of the work machine 100.

As shown in FIG. 1, one or more steering cylinders 112 may be located on each side of the work machine 100 (only one side shown) that can function in cooperation with a centrally-located articulated joint 114. To affect steering, the steering cylinder 112 located on one side of the work machine 100 may extend while the steering cylinder 112 located on the opposite side of the work machine 100 simultaneously retracts, thereby causing a forward end of the work machine 100 to pivot about the articulated joint 114 relative to a back end of the work machine 100. It should be noted that the number of the steering cylinders 112, as well as the configuration and connection of the steering cylinders 112 in the work machine 100 may vary.

A person of ordinary skill in the art would appreciate that the extension and retraction of the steering cylinder 112 may be accomplished by creating an imbalance of force on a piston assembly (not shown in figure) disposed within a tube of the steering cylinder 112. In one embodiment, each of the steering cylinders 112 may include a first chamber and a second chamber separated by the piston assembly. The piston assembly may include a piston axially aligned with and disposed within the tube.

The piston may include two opposing hydraulic surfaces, one associated with each of the first and second chambers. The first and second chambers may be selectively supplied with a pressurized fluid and drained of the pressurized fluid to create an imbalance of force on the two surfaces that causes the piston assembly to axially move within the tube. For example, a fluid pressure within the first hydraulic chamber acting on a first hydraulic surface being greater than a fluid pressure within the second hydraulic chamber acting on a second opposing hydraulic surface may cause the piston assembly to displace to increase the effective length of steering cylinder 112. Similarly, when a fluid pressure acting on the second hydraulic surface is greater than a fluid pressure acting on the first hydraulic surface, the piston assembly may retract within the tube to decrease the effective length of steering cylinder 112. Moreover, in one embodiment, any sealing member, such as an o-ring, may be connected to the piston to restrict a flow of fluid between an internal wall of the tube and an outer cylindrical surface of the piston.

As illustrated in FIG. 1, the steering system 104 may be connected to the power source 102 via an input shaft 116 through a torque converter 118. Alternatively, the steering system 104 may be connected to the power source 102 via a gear box (not shown), connected directly to the power source 102, or connected to the power source 102 in any other manner known in the art.

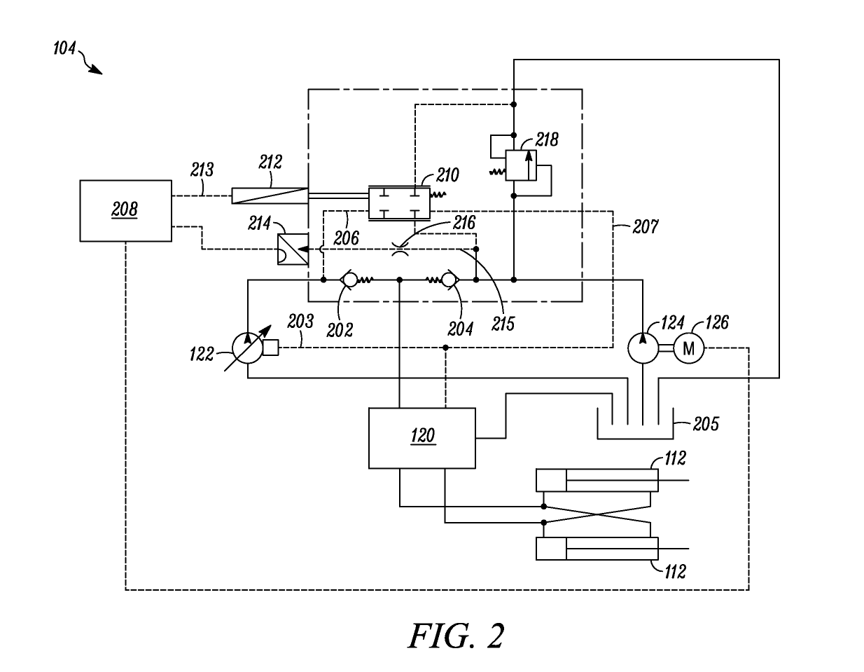

The steering system 104 may include a steering control valve 120, a primary source of pressurized fluid 122 and a secondary source of pressurized fluid 124. The steering control 120 valve may be fluidly connected to the steering cylinder 112, as shown in FIG. 2, to control actuation of the steering cylinder 112. In particular, the steering control valve 120 may include at least one valve element that functions to meter pressurized fluid into the steering cylinder 112. In one embodiment, the steering control valve 120 may be solenoid actuated against a spring bias, or any other directional valve mechanism. Also, the steering control valve 120 may be hydraulically actuated, mechanically actuated, pneumatically actuated, or actuated in any other suitable manner.

The movement of the steering control valve 120 may control the flow of the pressurized fluid into and/or out of the steering cylinders 112. It should be understood that although only one steering control valve 120 is depicted in the accompanied figures, the steering system 104 may include more steering control valves 120 such that a separate steering control valve may be associated with each steering cylinder 112.

The steering control valve 120 may be fluidly connected to both the primary and secondary sources of pressurized fluid 122, 124. In one embodiment, as shown in FIG. 2 check valves 202, 204 may be disposed within fluid passageways from the primary and secondary source of pressurized fluid 122, 124. The check valves 202, 204 may ensure one-directional flow of the pressurized fluid towards the steering control valve 120 and prevent back-flow of the pressurized fluid from any one of the primary or secondary source of pressurized fluid 122, 124 to the other.

In one embodiment, the primary source of pressurized fluid 122 may be a fixed displacement pump, a variable displacement pump, a variable flow pump, or any other source of pressurized fluid known in the art. The primary source of pressurized fluid 122 may be configured to provide a flow of pressurized fluid in the steering system 104. The primary source of pressurized fluid 122 may be drivably connected to the power source 102 by, for example, a countershaft, a belt, an electrical circuit, or in any other suitable manner. It should be noted that the primary source of pressurized fluid 122 may also supply the pressurized fluid to other circuits in the work machine 100.

In one embodiment, the primary source of pressurized fluid 122 may sense a load pressure requirement from the steering control valve 120 via communication line 203. A signal indicative of the load pressure requirement associated with the steering command may be sent from steering control valve 120 to the primary source of pressurized fluid 122.

The secondary source of pressurized fluid 124 may include a ground-driven pump, an accumulator, or an electric-driven pump. In one example, the illustrated secondary source of pressurized fluid 124 may be an electric-driven pump. To this end, the secondary source of pressurized fluid 124 can be connected to an electric motor 126, which can be used to drive the secondary source of pressurized fluid 124. The electric motor 126 may be an AC drive motor or a DC drive motor, depending on the application. Moreover, the steering control valve 120 and/or the primary and secondary source of pressurized fluid 122, 124 may be connected to a tank 205 or sump to allow drainage of the pressurized fluid in the steering system 104.

A person of ordinary skill in the art will appreciate that the connections shown in the accompanied figures depict an exemplary scenario. Other arrangements of the primary and secondary source of pressurized fluid 122, 124 may be utilized. It should be understood that the secondary source of pressurized fluid 124 may be provided as a back-up power source in the event that the primary source of pressurized fluid 122 may experience a failure, such as deactivated, defected, damaged, or otherwise non-operable.

To determine the operational health of the primary source of pressurized fluid 122, in one example, a controller 208 can be configured to determine and/or monitor a margin pressure of the primary source of pressurized fluid 122. The margin pressure can be determined based on a co-relation of the load pressure requirement and a discharge pressure from the primary source of pressurized fluid 122. For example, the margin pressure may be the differential pressure between the discharge pressure from the primary source of pressurized fluid 122 and the load pressure requirement from the steering control valve 120.

During healthy operation, the primary source of the pressurized fluid 122 can maintain a margin pressure. Hence, when the primary source of pressurized fluid 122 is functioning properly, the discharge pressure from the primary source of pressurized fluid 122 can be greater than the load pressure requirement from the steering control valve 120 to maintain the margin pressure.

In FIG. 2, in one embodiment, a spool blank 210 and a position sensor 212 may be used to communicate the margin pressure to the controller 208. The position sensor 212 can be operable to detect the position of the spool blank 210 relative to the body housing the spool blank 210. Various types of position sensors can be associated with the spool blank 210 to achieve the functionality described herein, such as a Linear Variable Differential Transformer (LVDT). LVDT is an electromechanical transducer that is capable of converting the rectilinear motion of the spool blank 210 into a corresponding electrical signal, from which the controller 208 through an algorithm calculates a relative position. It should be noted that the position sensor 212 can measure movements as small as a few millionths of an inch up to several inches, but are also capable of measuring positions up to ±20 inches (±0.5 m), depending on the application.

The spool blank 210 may be connected via first and second passageways 206, 207 to the primary source of pressurized fluid 122 and the steering control valve 120, respectively. To this end, the spool blank 210 may receive a signal indicative of the discharge pressure from the primary source of pressurized fluid 122 via the first passageway 206 on a first side of the spool blank 210. The spool blank 210 may receive a signal indicative of the load pressure requirement from the steering control valve 120 via the second passageway 207 on a second side of the spool blank 210, opposite the first side. It should be noted that a biasing force may be associated with the spool blank 210 via a biasing member such as a spring. The biasing member may be applicable on the second side of the spool blank 210 which receives the signal indicative of the load pressure requirement to bias the spool blank 210 to a first steady state position.

On the basis of a received signal indicative of the load pressure requirement and the biasing force on the second side of the spool blank 210 and a received signal indicative of the discharge pressure from the primary source of pressurized fluid 122 on the first side of the spool blank 210, the spool blank 210 may either move between a first position and a second position. When the spool blank 210 is in the first position, the discharge pressure from the primary source of pressurized fluid 122 is less than the load pressure requirement and the biasing force. Alternatively, when the discharge pressure from the primary source of the pressurized fluid 122 is greater than the load pressure requirement and the biasing force, the spool blank 210 may move to the second position.

As shown in FIG. 2, the spool blank 210 can be coupled to the position sensor 212. The position sensor 212 may be communicably coupled with the controller 208 via a communication line 213. The position sensor 212 may send a signal based on the position of the spool blank 210 to the controller 208 via the communication line 213, which can be indicative of the margin pressure of the primary source of pressurized fluid 122.

In one example, a differential pressure sensor (not shown in figure) may be communicably coupled to the controller 208. The differential pressure sensor may be positioned to detect the load pressure requirement from the steering control valve 120 and the discharge pressure from the primary source of pressurized fluid 122. For instance, the differential pressure sensor may be placed between the steering control valve 120 and the primary source of pressurized fluid 122. Subsequently, the differential pressure sensor may send a signal indicative of the margin pressure of the primary source of pressurized fluid 122 to the controller 208.

Alternatively, in another embodiment, the controller 208 may be communicably coupled to the steering control valve 120 and may receive the signal indicative of the load pressure requirement from the steering control valve 120. The controller may also be coupled to a pressure sensor (not shown in figures) associated with the primary source of pressurized fluid 122. The controller 208 may receive the signal indicative of the discharge pressure from the primary source of pressurized fluid 122 via the pressure sensor. The controller 208 may then determine the monitored margin pressure based on the received signals from the steering control valve 120 and the pressure sensor.

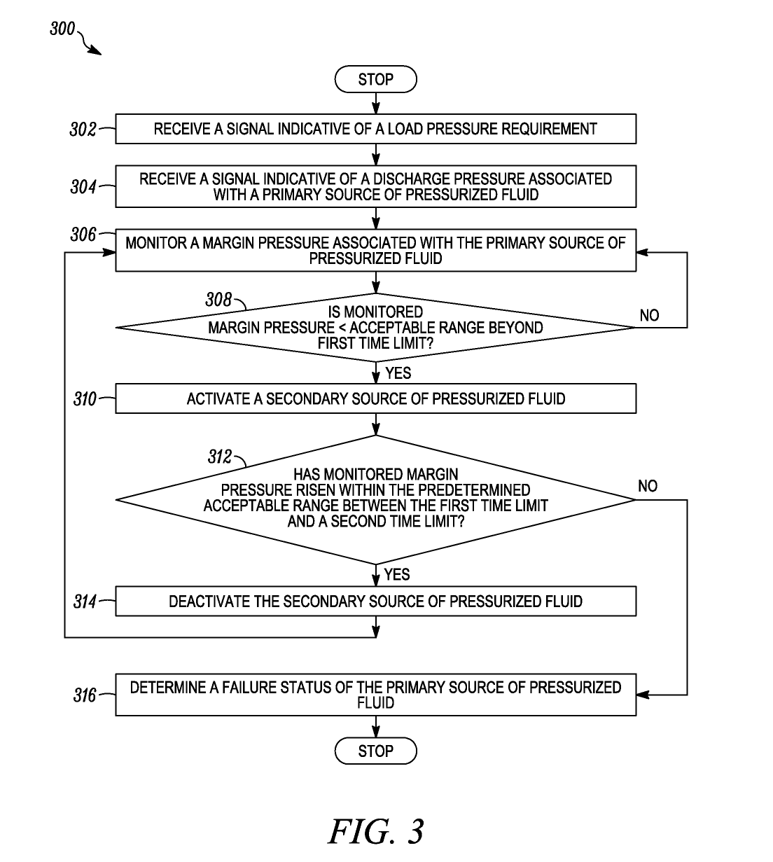

In one example, the controller 208 may determine an operational status of the primary source of the pressurized fluid 122 based on the monitored margin pressure. The determination of the operational status of the primary source of pressurized fluid 122 by the controller 208 will be described in detail in connection with FIG. 3.

Also, as shown in FIG. 2, a pressure sensor 214 may be communicably coupled to the controller 208 and the secondary source of pressurized fluid 124 via a third passageway 215. The pressure sensor 214 may provide a signal indicative of a discharge pressure from the secondary source of pressurized fluid 124 to the controller 208. This discharge pressure signal may be provided to the controller 208 either periodically or based on manual activation through operator controls when the work machine 100 is running. In one example, the discharge pressure signal may be provided based on certain predetermined machine conditions. The discharge pressure signal may be used by the controller 208 to determine an operational health for the secondary source of pressurized fluid 124. The detailed explanation of determining the operational health for the secondary source of pressurized fluid 124 will be provided in conjunction with FIG. 3.

In one example, the steering system 104 may include one or more signal dampening orifices 216 disposed in either or all of the passageways, such as the third passageway 215, to reduce signal fluctuations or noise detected by the pressure sensor 214. In one example, a relief valve 218 may be fluidly connected to the secondary source of pressurized fluid 124. The relief valve 218 may prevent over pressurization of the secondary source of pressurized fluid 124. A person of ordinary skill in the art will appreciate that other electrical, electronic, hydraulic or other components not described herein may be part of the steering system 104, without any limitation.

The controller 208 may embody a single microprocessor or multiple microprocessors that perform one or more operations for determination of the operational status for the primary source of pressurized fluid 122. Numerous commercially available microprocessors can be configured to perform the functions of controller 208. It should be appreciated that controller 208 may additionally perform other functionality not described herein. The controller 208 may include a memory, a secondary storage device, a processor, and any other components. Moreover, depending on the application, various other circuits may be associated with the controller 208 such as power supply circuitry, signal conditioning circuitry, solenoid driver circuitry, and other types of circuitry.

### INDUSTRIAL APPLICABILITY

Work machines 100 can be provided with the secondary source of pressurized fluid 124 either as standard equipment or as optional attachments to meet local regulations and/or customer preferences. The secondary source of pressurized fluid 124 may act as a back-up steering power source in the event that the primary source of pressurized fluid 122 experiences failure.

In the instance of using an electric-driven pump as the secondary source of pressurized fluid 124, additional regulations may require an ability to test the functionality of the primary and/or secondary source of pressurized fluid 122, 124 and communicate an indication of an appropriate status to the operator, based on whether certain pre-determined test thresholds are achieved.

Presently known solutions include the use of multiple pressure sensors or transducers to detect a failure of the primary and secondary source of pressurized fluid 122, 124 and accordingly alert the operator. The failure detection in these systems is based on the independent discharge pressures from each of the primary and secondary source of pressurized fluid 122, 124. However, these solutions are known to raise false warnings even when the primary source of pressurized fluid 122 is in a healthy condition. For example, when the healthy primary source of pressurized fluid 122 is running at lower than normal conditions, like in response to over-running loads, the secondary source of pressurized fluid 124 is activated and the warning is issued to the operator.

The determination of the operational status of the primary source of pressurized fluid 122 based on the monitored margin pressure can facilitate the reduction of faulty warnings attributed to the steering system 104 when the primary source of pressurized fluid 122 is indeed healthy. The monitored margin pressure can be based on a co-relation of the load pressure requirement and the discharge pressure from the primary source of pressurized fluid 122. The margin pressure may be a good indicator of pump flow output in a load-sensing pump architecture, thereby improving determination of capability of the primary source of pressurized fluid 122, resulting in minimum false failure indications. In one example, the determination of the operational health of the secondary source of pressurized fluid 124 may also be beneficial. To this end, the determination of the operational status of the primary and/or secondary source of pressurized fluid 122, 124 by the controller 208 while the work machine 100 is running may limit excessive stoppages of productive machine operation.

FIG. 3 depicts a process diagram to determine the operational status of the primary and/or secondary source of pressurized fluid 122, 124. At step 302, the signal indicative of the load pressure requirement associated with the steering command may be received. For example, the signal may be received at the second side of the spool blank 210 via the second passageway 207. In another example, the signal may be received by the differential pressure sensor (if provided). Alternatively, in one embodiment, the controller 208 may receive the signal indicative of the load pressure requirement from the steering control valve 120.

At step 304, the signal indicative of the discharge pressure associated with the primary source of pressurized fluid 122 may be received. For example, the signal may be received at the first side of the spool blank 210, which is in communication with the primary source of pressurized fluid 122 via the first passageway 206. In another example, the signal may be received by the differential pressure sensor (if provided). In yet another example, the controller 208 may receive the signal indicative of the discharge pressure associated with the primary source of pressurized fluid 122 via the pressure sensor connected to the primary source of pressurized fluid 122.

On the basis of the signal indicative of the load pressure requirement and the biasing force associated with the spool blank 210 on the second side, and the signal indicative of the discharge pressure from the primary source of pressurized fluid 122, on the first side of the spool blank 210, the spool blank 210 may move between the first position and the second position.

The spool blank 210 may move to the second position when the signal indicative of the discharge pressure from the primary source of pressurized fluid 122 is greater than that the signal indicative of the load pressure requirement and the biasing force. On the other hand, the spool blank 210 may move to the first position when the signal indicative of the discharge pressure from the primary source of pressurized fluid 122 is less than the signal indicative of the load pressure requirement and the spring force. Depending on the position of the spool blank, the position sensor 212 may accordingly send a signal indicative of the margin pressure based on the position of the spool blank 210 to the controller 208 via the communication line 213.

In step 306, the controller 208 may monitor the margin pressure associated with the primary source of pressurized fluid 122. The controller 208 may determine the operational status of the primary source of pressurized fluid 122 based on the monitored margin pressure. During normal operation, the primary source of pressurized fluid 122 may operate in any one of two states. In a first state, the primary source of pressurized fluid 122 may maintain the margin pressure. In this condition, no further action is taken since the primary source of pressurized fluid 122 is healthy. However, in a second state of the primary source of the pressurized fluid 122, the margin pressure may not be maintained. In other words, in this situation, the discharge pressure from the primary source of pressurized fluid 122 is less than the load pressure requirement from the steering command. Hence, at step 308, the controller 208 checks if the monitored margin pressure is lesser than a pre-determined acceptable range beyond a first time limit.

In one embodiment, temporary inability of the primary source of pressurized fluid 122 to maintain margin pressure within the first time limit may be acceptable. The first time limit may be a short pre-decided interval of time which may be ascertained and fixed for the work machine 100. The first time limit may depend on operating parameters of the work machine 100, for example, low engine speed, high steering command, response time of the primary source of pressurized fluid 122, fluid viscosity and the like. Such a situation may arise generally due to a combination of low engine speed and high steering command. If the primary source of pressurized fluid 122 recovers within the first time limit, no fault may be generated and no remedial action may be taken.

However, if the primary source of pressurized fluid 122 remains below the pre-determined acceptable range beyond the first time limit, the secondary source of pressurized fluid 124 may be activated at step 310. In one embodiment, the operator may be provided with a suitable notification when the secondary source of pressurized fluid 124 is activated. The notification may involve some manner of audio and/or visual indicator, such as illuminating a warning lamp, sounding an alarm, displaying a message on a screen or user interface, or any other method of indicating to the operator that a fault has occurred with respect to the working of the primary source of the pressurized fluid 122.

Thereafter, at step 312, the controller 208 may determine if the monitored margin pressure has risen within the pre-determined acceptable range between the first time limit and a second time limit. It should be noted that the rise in the monitored margin pressure is indicative of a recovery of the primary source of pressurized fluid 122.

The second time limit is also a pre-determined fixed time limit. The second time limit may be greater than the first time limit. It should be understood that the second time limit may be fixed based on certain operating parameters of the work machine 100, such as type of the work machine 100, type of the engine, steering linkage configuration and the like. If the monitored margin pressure has risen to within the pre-determined acceptable range between the first and second time limit in step 312, then the controller 208 may determine a recovered margin pressure status for the primary source of pressurized fluid 122.

At step 314, the secondary source of pressurized fluid 124 may be de-activated, based on the recovered margin pressure status of the primary source of pressurized fluid 122. In one embodiment, an appropriate notification of the deactivation of the secondary source of the pressurized fluid 124 may be conveyed to the operator. This notification may be provided via an audio and/or visual indicator, such as by changing the warning light, sounding another alarm, displaying a message related to the failure of the primary source of pressurized fluid 122, and the like.

However, if the primary source of pressurized fluid 122 fails to recover to within the pre-determined acceptable range between the first and second time limit, at step 316, a failure status for the primary source of pressurized fluid 122 may be determined by the controller 208. A person of ordinary skill in the art will appreciate that on failure of the primary source of pressurized fluid 122 to recover beyond the second time limit, the continued use of the primary source of pressurized fluid 122 may pose as an operational hindrance in the work machine 100.

Additionally, frequent recovery of the primary source of pressurized fluid 122 between the first time limit and the second time limit may be undesirable. Hence, in one example, a frequency of change in the activation and deactivation of the secondary source of pressurized fluid 124 may be determined by the controller 208. The determined frequency may then be stored in a memory for failure detection.

In one embodiment, the memory may include any suitable database or data structure configured to store the determined count for retrieval by the controller 208 at a later stage. The memory may either be intrinsic or extrinsic to the controller 208. In another embodiment, the stored frequency of change may be retrieved from the memory by the controller 208 in order to identify activation duty cycle of the secondary source of pressurized fluid 124 as a root cause of failure of the primary source of pressurized fluid 122.

In another example, the controller 208 may also determine the operational health of the secondary source of pressurized fluid 124 on a periodic basis for testing an output capability of the secondary source of pressurized fluid 124. The determination of the operational health of the secondary source of pressurized fluid 124 may be initiated based on certain machine conditions. The determination of the operational health of the secondary source of pressurized fluid 124 may be initiated manually, through operator controls.

On initiation of this test for the secondary source of pressurized fluid 124, the secondary source of pressurized fluid 124 may be switched on or activated. Then, the discharge pressure from the secondary source of pressurized fluid 124 may be monitored by the controller 208. Subsequently, the controller 208 may determine if the discharge pressure from the secondary source of pressurized fluid 124 falls within a pre-determined acceptable parameter.

If the discharge pressure from secondary source of pressurized fluid 124 meets the above-mentioned criteria, the test may be concluded and the secondary source of pressurized fluid 124 may be switched off or de-activated. However, if the discharge pressure from the secondary source of pressurized fluid 124 does not fall within the pre-determined parameter, a failure status for the secondary source of pressurized fluid 124 may be determined by the controller 208. In this case, the secondary source of pressurized fluid 124 may continue to remain on. In one example, the controller 208 may send a notification to the operator of the failure of the secondary source of pressurized fluid 124. The notification may be an audio and/or visual indicator, such as by a message, an alert, a warning signal, or any other suitable status indicator of notifying the operator of the failure status of the secondary source of pressurized fluid 124.

As described above, the disclosure relates to work machines 100 utilizing a load-sensing hydraulic architecture for the primary source of pressurized fluid 122 and the electric-driven motor pump as the secondary source of pressurized fluid 124. Typically, such system architectures are widely utilized in high-volume medium sized wheel loader and motor grader machines. A person of ordinary skill in the art will appreciate that the steering system 104 shown in the accompanied figures is merely on an exemplary basis and does not limit the scope of this disclosure. Other components not described herein may be included in the work machine 100 without any limitation.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A steering system comprising:
a steering control valve;
a primary source of pressurized fluid fluidly connected to the steering control valve, wherein the primary source of pressurized fluid is configured to sense a load pressure requirement from the steering control valve;
a secondary source of pressurized fluid fluidly connected to the steering control valve; and
a controller communicably coupled to the primary and secondary sources of pressurized fluid, the controller configured to:
monitor a margin pressure of the primary source of pressurized fluid; and
determine an operational status of the primary source of pressurized fluid based on the monitored margin pressure.

2. The steering system of claim 1, wherein the steering control valve is connected to at least one steering cylinder.

3. The steering system of claim 1 further including:
a spool blank configured to receive the load pressure requirement from the steering control valve and the discharge pressure from the primary source of pressurized fluid; and
a position sensor connected with the spool blank and communicably coupled with the controller, wherein the position sensor sends a signal, to the controller, indicative of the margin pressure of the primary source of pressurized fluid based on a position of the spool blank.

4. The steering system of claim 1 further including a differential pressure sensor configured to receive the load pressure requirement from the steering control valve and the discharge pressure from the primary source of pressurized fluid.

5. The steering system of claim 4, wherein the differential pressure sensor is communicably coupled to the controller to send a signal indicative of the margin pressure of the primary source of pressurized fluid.

6. The steering system of claim 1 further including a pressure sensor connected to the secondary source of pressurized fluid, wherein the pressure sensor is communicably coupled to the controller to provide a signal indicative of a discharge pressure from the secondary source of pressurized fluid.

7. The steering system of claim 1, wherein the primary source of pressurized fluid includes at least one of a fixed displacement pump and a variable displacement pump.

8. The steering system of claim 1, wherein the secondary source of pressurized fluid includes at least one of a ground-driven pump, an accumulator, and an electric-driven pump.

9. The steering system of claim 1, wherein at least one of the steering control valve, the primary source of pressurized fluid and the secondary source of pressurized fluid is connected to a tank.

10. The steering system of claim 1 further including at least one relief valve hydraulically connected to the secondary source of pressurized fluid.

11. A method comprising:
receiving a signal indicative of a load pressure requirement associated with a steering command;
receiving a signal indicative of a discharge pressure associated with a primary source of pressurized fluid;
monitoring a margin pressure associated with the primary source of pressurized fluid based on the received signals; and
determining an operational status of the primary source of pressurized fluid based on the monitored margin pressure.

12. The method of claim 11, wherein the determining an operational status step further includes activating a secondary source of pressurized fluid to provide the pressurized fluid to a steering control valve when the monitored margin pressure remains below a predetermined acceptable range beyond a first time limit.

13. The method of claim 12 further including notifying an operator when the secondary source of pressurized fluid is activated.

14. The method of claim 12 further including determining a failure status for the primary source of pressurized fluid, if the monitored margin pressure remains below the pre-determined acceptable range beyond a second time limit.

15. The method of claim 14 further including notifying an operator of the determined failure status of the primary source of pressurized fluid.

16. The method of claim 12 further including deactivating the secondary source of pressurized fluid based on a recovered margin pressure status of the primary source of the pressurized fluid when the monitored margin pressure rises within the predetermined acceptable range between the first time limit and a second time limit.

17. The method of claim 16 further including:
determining a frequency of change between activating and deactivating the secondary source of pressurized fluid; and
storing the frequency of change for failure detection.

18. The method of claim 11 further including determining an operational health of a secondary source of pressurized fluid by:
activating the secondary source of pressurized fluid;
monitoring a discharge pressure associated with secondary source of pressurized fluid; and
determining a failure status of the secondary source of pressurized fluid if the monitored discharge pressure falls below a predetermined acceptable parameter.

19. The method of claim 18 further including notifying the operator of the determined failure status of the secondary source of pressurized fluid.

20. A machine comprising:
a power source;
a transmission;
a traction device; and
a steering system including:
a steering control valve;
a primary source of pressurized fluid fluidly connected to the steering control valve, wherein the primary source of pressurized fluid is configured to sense a load pressure requirement from the steering control valve;
a secondary source of pressurized fluid fluidly connected to the steering control valve; and
a controller communicably coupled to the primary and secondary sources of pressurized fluid, the controller configured to:
monitor a margin pressure of the primary source of pressurized fluid; and
determine an operational status of the primary source of pressurized fluid based on the monitored margin pressure.
